(19) United States
(12) Patent Application Publication
(10) Pub. No.: US 2006/0233533 A1
(43) Pub. Date: Oct. 19, 2006

(54) Information recording/reproducing system, information recording/reproducing apparatus and information recording/reproducing method

(76) Inventor: Yukari Hosoya, Kanagawa (JP)

Correspondence Address: William S. Frommer, Esq.;c/o FROMMER LAWRENCE & HAUG LLP, 745 FIFTH AVENUE, NEW YORK, NY, 10151, US

(21) Appl. No.: 11/402,183

(22) Filed: Apr. 11, 2006

(30) Foreign Application Priority Data
Apr. 15, 2005 (JP) 2005-119089

(51) Int. Cl. H04N 7/26

(52) U.S. Cl. 386/111

(57) ABSTRACT

Information recording/reproducing system decodes an MPEG data stream constituted of one-grouped pictures of I2, B0, B1, P5, B3, B4, P8, B6, B7, P11, B9, B10, P14, B12, and B13 in turn on B picture, P picture and I picture to become the MPEG data stream constituted of one-grouped pictures of I2, P5, B3, B4, P8, B6, B7, P11, B9, B10, P14, B12, B13, I2, B0, and B1 in turn on the B picture, the P picture and the I picture. The system produces a reproduced image that is constituted of one-grouped pictures of I2, B3, B4, P5, B6, B7, P8, B9, B10, P11, B12, B13, P14, B0, and B1 in turn on the B picture, the P picture and the I picture. The reproduced image can prevent any necessary picture from being lacked and get any smoothly reverse reproduction images.

### CROSSREFERENCE TO RELATED APPLICATION

The present invention contains subject matter related to Japanese Patent Application No. JP2005-119089 filed in the Japanese Patent Office on Apr. 15, 2005, the entire contents of which being incorporated herein by reference.

### BACKGROUND OF THE INVENTION

1. Field of the Invention

The present invention relates to an information recording/reproducing system, an information recording/reproducing apparatus and an information recording/reproducing method. More particularly, it relates to an AV sever system that processes audio/video data streams.

2. Description of Related Art

Recently, the AV server system has been often used in a broadcast station, an audio/video information distribution system or the like when editing any audio/video information. The AV server system has data recording/reproducing apparatus, data storage device and the like. The data recording/reproducing apparatus encodes and compresses (or performs encoding on) any audio/video information according to any data compression standard such as MPEG when recording the data. Additional information such as header information is added to the coded and compressed audio/video data, thereby producing MPEG stream data.

The data recording/reproducing apparatus reads the MPEG data stream from the data storage device when reproducing data, to decode and decompress (or performs decoding on) the MPEG data stream. Any decoded and decompressed audio/video data is used as audio/video information. The data recording/reproducing apparatus transmits such audio/video information to a monitor.

Such the AV server is equipped with plus and minus direction reproduction modes. In the plus direction reproduction mode (forward direction reproduction mode), a monitored video image is moves forward while in the minus direction reproduction mode (reverse direction reproduction mode), a monitored video image is moves reverse. To implement these reproduction modes, read-out of the MPEG data stream and decode processing thereof are figured out a good way.

FIG. 1A through 1C show an example of producing the MPEG data stream in a case of the forward direction reproduction mode on related art. FIG. 1A illustrates an MPEG data stream ENCin that an encoder receives in a data-recording mode. In this MPEG data stream ENCin, 15 pictures of B0 through P14 on B picture, P picture and I picture are grouped as one group of pictures (GOP). The B picture is predicted with bidirectional prediction from previous and next I and P pictures or previous and next P pictures. P picture is predicted with prediction from previous I or P picture. Pictures B0, B1 are predicted with bidirectional prediction from picture P14 of previous GOP and picture I2 of the current GOP. To the MPEG data stream thus encoded, any additional information is added and such the MPEG data stream thus added is stored in the data storage device.

When reproducing the data, the MPEG data stream is read out of the data storage device and the additional information is separated therefrom, thereby enabling audio/video data to be decoded from the MPEG data stream. FIG. 1B illustrates an MPEG data stream ENCout (DECin) that a decoder receives in a data-reproducing mode. In this MPEG data stream ENCout, 15 pictures of I2, B0, B1, P5, B3, B4, P8, B6, B7, P11, B9, B10, P14, B12, and B13 in turn on B picture, P picture and I picture relative to the previous GOP are grouped as one GOP. If decoding the MPEG data stream ENCout, the MPEG data stream DECout is given as shown in FIG. 1C. The B picture is predicted with bidirectional prediction from previous and next I and P pictures or previous and next P pictures. P picture is predicted with prediction from previous I or P picture. In the MPEG data stream DECout shown in FIG. 1C, pictures B0, B1 are predicted with bidirectional prediction from picture P14 of previous GOP and picture I2 of the current GOP.

### SUMMARY OF THE INVENTION

If trying to reproduce pictures B0 though P14 from the MPEG data stream in the reverse direction reproduction mode, it is necessary to have data of two GOPs because the items of data of the picture I2 of the previous GOP to the picture B13 of the current GOP are decoded in turn and the picture P14 obtained by this decoding is used, in order to get an image of the current GOP. In other words, it is difficult to produce the pictures B0, B1 in the MPEG data stream if picture P14 of the previous GOP is lacked.

If any information recording/reproducing apparatus in related art produces one picture in the reverse direction reproduction mode of the MPEG data stream based on the forward direction reproduction mode on related art, it is necessary to perform the decoding on the data of two GOP (30 frames), previous and current GOPs, in order to get a desired picture.

It is also necessary to decode the pictures from a top of GOP in order to get a desired image, for every time. This causes the reproduction in the minus direction at a same speed as the recording speed to be very difficult. Particularly, in a variable speed reproduction, when a reproduction direction is switched from its plus direction to its minus direction, a necessary picture may be lacked and it is difficult to get any smoothly reverse reproduction images.

It is desirable to provide an information recording/reproducing system, an information recording/reproducing apparatus and an information recording/reproducing method that are possible to prevent any necessary picture from being lacked and to get any smoothly reverse reproduction images even if, in a variable speed reproduction, a reproduction direction is switched from its plus direction to its minus direction.

According to an embodiment of the invention, there is provided an information recording/reproducing system. The information recording/reproducing system has data storage device that stores an MPEG data stream constituted of one-grouped pictures of I2, B0, B1, P5, B3, B4, P8, B6, B7, P11, B9, B10, P14, B12, and B13 in turn on B picture, P picture and I picture. The system also has control device that controls the data storage device to read the MPEG data stream constituted of one-grouped pictures of I2, P5, B3, B4, P8, B6, B7, P11, B9, B10, P14, B12, B13, I2, B0, and B1 in turn on the B picture, the P picture and the I picture. The system further has information recording/reproducing apparatus including a memory. The apparatus decodes the MPEG data stream constituted of one-grouped pictures read out of the data storage device by the control device to produce B pictures from previous and next P and I pictures or previous and next P pictures and to produce P pictures from previous I picture or previous P picture, stores in the memory reproduced image data that is constituted of one-grouped pictures of I2, B3, B4, P5, B6, B7, P8, B9, B10, P11, B12, B13, P14, B0, and B1 in turn on the B picture, the P picture and the I picture, and controls data-reading order out of the memory.

In the embodiment of the information recording/reproducing system according to the invention, the MPEG data stream constituted of one-grouped pictures of I2, B0, B1, P5, B3, B4, P8, B6, B7, P11, B9, B10, P14, B12, and B13 in turn on B picture, P picture and I picture is stored in the data storage device. On the assumption of this, the control device controls the data storage device to read the MPEG data stream constituted of one-grouped pictures of I2, P5, B3, B4, P8, B6, B7, P11, B9, B10, P14, B12, B13, I2, B0, and B1 in turn on the B picture, the P picture and the I picture. The information recording/reproducing apparatus decodes the MPEG data stream constituted of one-grouped pictures read out of the data storage device by the control device to produce B pictures from previous and next P and I pictures or previous and next P pictures and to produce P pictures from previous I picture or previous P picture.

For example, if using two decoders, the second decoder starts decoding picture of I2 in a next group at the same time as the first decoder decodes the picture of B1 in a current group after the first decoder has decoded the picture of B0 in the current group. The information recording/reproducing apparatus stores in a memory, for example, jog memory, reproduced image data that is constituted of one-grouped pictures of I2, B3, B4, P5, B6, B7, P8, B9, B10, P11, B12, B13, P14, B0, and B1 in turn on the B picture, the P picture and the I picture.

Thus, the embodiment rapidly can produce reverse reproduction images that have continuity from almost one-grouped pictures in the MPEG data stream and store them in the jog memory. By controlling data-reading out of the jog memory allow the reproduction in the reverse direction at a same speed as the recording speed and an improvement in response to be implemented in MPEG long GOP. Further, in a variable speed reproduction, even when a reproduction direction is switched from its plus direction to its minus direction and vice versa, it is possible to get any smoothly reverse reproduction images without lacking any necessary pictures (without any skipping) by using the images stored in the jog memory.

According to another embodiment of the invention, there is provided information recording/reproducing apparatus. The apparatus has data storage portion that stores an MPEG data stream constituted of one-grouped pictures of I2, B0, B1, P5, B3, B4, P8, B6, B7, P11, B9, B10, P14, B12, and B13 in turn on B picture, P picture and I picture. The apparatus also has control portion that controls the data storage portion to read the MPEG data stream constituted of one-grouped pictures of I2, P5, B3, B4, P8, B6, B7, P11, B9, B10, P14, B12, B13, I2, B0, and B1 in turn on the B picture, the P picture and the I picture. The apparatus further has information recording/reproducing portion including a memory. The information recording/reproducing portion decodes the MPEG data stream constituted of one-grouped pictures read out of the data storage portion by the control portion to produce B pictures from previous and next P picture and I picture or previous and next P pictures and to produce P pictures from previous I picture or previous P picture. The information recording/reproducing portion stores in a memory, for example, jog memory, reproduced image data that is constituted of one-grouped pictures of I2, B3, B4, P5, B6, B7, P8, B9, B10, P11, B12, B13, P14, B0, and B1 in turn on the B picture, the P picture and the I picture. The information recording/reproducing portion controls data-reading order out of the memory.

In the embodiment of the information recording/reproducing apparatus according to the invention, the MPEG data stream constituted of one-grouped pictures of I2, B0, B1, P5, B3, B4, P8, B6, B7, P11, B9, B10, P14, B12, and B13 in turn on B picture, P picture and I picture is stored in the data storage portion. On the assumption of this, the control portion controls the data storage portion to read the MPEG data stream constituted of one-grouped pictures of I2, P5, B3, B4, P8, B6, B7, P11, B9, B10, P14, B12, B13, I2, B0, and B1 in turn on the B picture, the P picture and the I picture. The information recording/reproducing portion decodes the MPEG data stream constituted of one-grouped pictures read out of the data storage portion by the control portion to produce B pictures from previous and next P and I pictures or previous and next P pictures and to produce P pictures from previous I picture or previous P picture. The information recording/reproducing apparatus stores in the jog memory the reproduced image data that is constituted of one-grouped pictures of I2, B3, B4, P5, B6, B7, P8, B9, B10, P11, B12, B13, P14, B0, and B1 in turn on the B picture, the P picture and the I picture.

Thus, the embodiment rapidly can produce reverse reproduction images that have continuity from almost one-grouped pictures in the MPEG data stream and store them in the jog memory. By controlling data-reading out of the jog memory allow the reproduction in the reverse direction at a same speed as the recording speed and an improvement in response to be implemented in MPEG long GOP. Further, in a variable speed reproduction, even when a reproduction direction is switched from its plus direction to its minus direction and vice versa, it is possible to get anysmoothlyreverse reproduction images without lacking anynecessarypictures (without any skipping) byusing the images stored in the jog memory.

According to further embodiment of the invention, there is provided information recording/reproducing method. The method has the steps of grouping an MPEG data stream constituted of pictures of I2, P5, B3, B4, P8, B6, B7, P11, B9, B10, P14, B12, B13, I2, B0, and B1 in turn on the B picture, the P picture and the I picture as one group relative to the MPEG data stream constituted of one-grouped pictures of I2, B0, B1, P5, B3, B4, P8, B6, B7, P11, B9, B10, P14, B12, and B13 in turn on B picture, P picture and I picture and recorded in this order and decoding the MPEG data stream constituted of one-grouped pictures to produce B pictures from previous and next P picture and I picture or previous and next P pictures and to produce P pictures from previous I picture or previous P picture. The method also has the steps of storing in a memory reproduced image data that is constituted of one-grouped pictures of I2, B3, B4, P5, B6, B7, P8, B9, B10, P11, B12, B13, P14, B0, and B1 in turn on the B picture, the P picture and the I picture and controlling data-reading order out of the memory.

In the embodiment of the information recording/reproducing method according to the invention, when producing any reverse reproduction images, they can be rapidly produced, the images having continuity, from almost one-grouped pictures in the MPEG data stream and stored, for example, in the jog memory. By controlling data-reading out of the jog memory allow the reverse direction reproduction at a same speed as the recording speed and an improvement in response to be implemented in MPEG long GOP. Further, in a variable speed reproduction, even when a reproduction direction is switched from its plus direction to its minus direction and vice versa, it is possible to get any smoothly reverse reproduction images without lacking any necessary pictures by using the images stored in the jog memory.

The concluding portion of this specification particularly points out and directly claims the subject matter of the present invention. However that skill in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIGS. 1A through 1C are diagrams each for showing a production example of MPEG data stream when forward and reverse direction reproductions (in plus and minus direction reproductions) are carried out relative to related art;

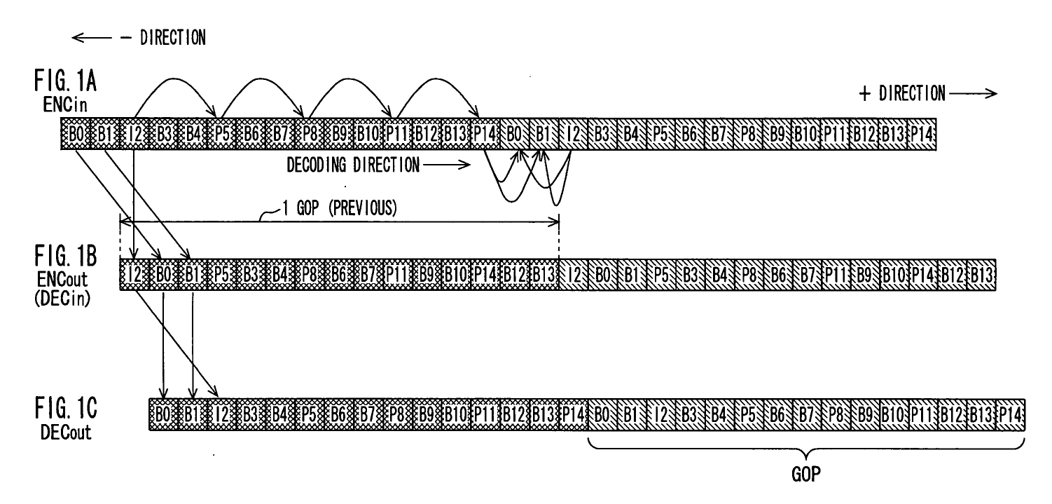

FIG. 2 is a block diagram for showing a configuration of an embodiment of AV server system according to the invention;

FIG. 3 is a diagram for showing an internal configuration of an embodiment of the AV server according to the invention;

FIG. 4 is a diagram for showing an internal configuration of an embodiment of data recording/reproducing device according to the invention;

FIG. 5 is a diagram for showing an example of data structure in MXF file;

FIGS. 6A and 6B are diagrams each for showing an example for grouping the pictures in MPEG data stream when a reverse (minus) direction reproduction is carried out;

FIGS. 7A through 7E are diagrams each for showing a timing example for a start of decoding in each of the DEC substrates;

FIGS. 8A and 8B are diagrams each for showing a transition example in an amount of stored data within a jog memory; and

FIG. 9 is a flowchart for showing operations of the embodiment of the data recording/reproducing device according to the invention when the reverse (minus) direction reproduction is carried out.

### DESCRIPTION OF THE INVENTION

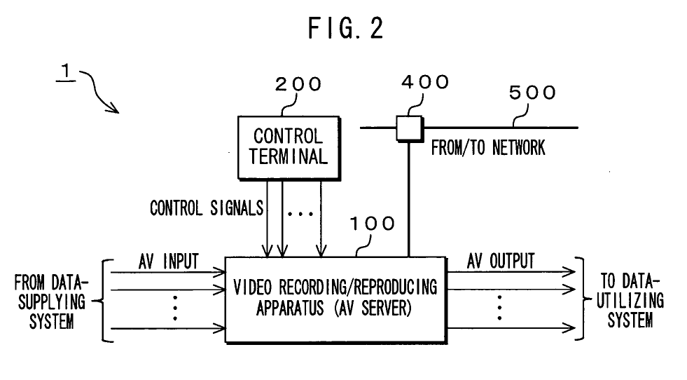

Referring now to the drawings, preferred embodiments of an information recording/reproducing system, an information recording/reproducing apparatus, and an information recording/reproducing method according to the invention will be described specifically below. FIG. 2 shows a configuration of a first embodiment of an AV server system 1 according to the invention.

The AV server system 1 shown in FIG. 2 is an example of an information recording/reproducing system. In a broadcast station or an information distribution center on video and audio (including sound and music), the AV server system 1 writes and records an audio and/or video (AV) data stream in any data storage device and/or reads the AV data stream out of the data storage device and reproduces the AV data stream.

The AV server system 1 has a video recording/reproducing apparatus (hereinafter, referred to as “AV server 100”) and a control terminal 200. When recording the data, the AV server 100 receives pieces of information on video and audio materials (AV input) and encodes them as the data under the recording control of the control terminal 200. The AV server 100 then adds any additional information to the encoded data to produce a data stream with a predetermined data format. The AV server 100 records and stores this data stream.

When reproducing the data, the AV server 100 reads the data stream with a predetermined data format, which has been recorded and stored, under the reproducing control of the control terminal 200. The AV server 100 decodes the read data streamwith apredetermined data format. After decoding, the AV server 100 stores the decoded data in a jog memory and outputs the data (AV output) with controlling data-reading order out of the jog memory. The jog memory is a memory for implementing the reverse direction reproduction at a same speed as the recording speed using a jog. The AV server 100 is connected with a network 500 through a hub 400. The AV server 100 receives or transmits the data stream with a predetermined data format from or to the network 500. This is because a priority of an access from the network 500 is established so that the AV server 100 can record and administrate file format data such as MXF file format data and AVI format data as it is if it is at all possible.

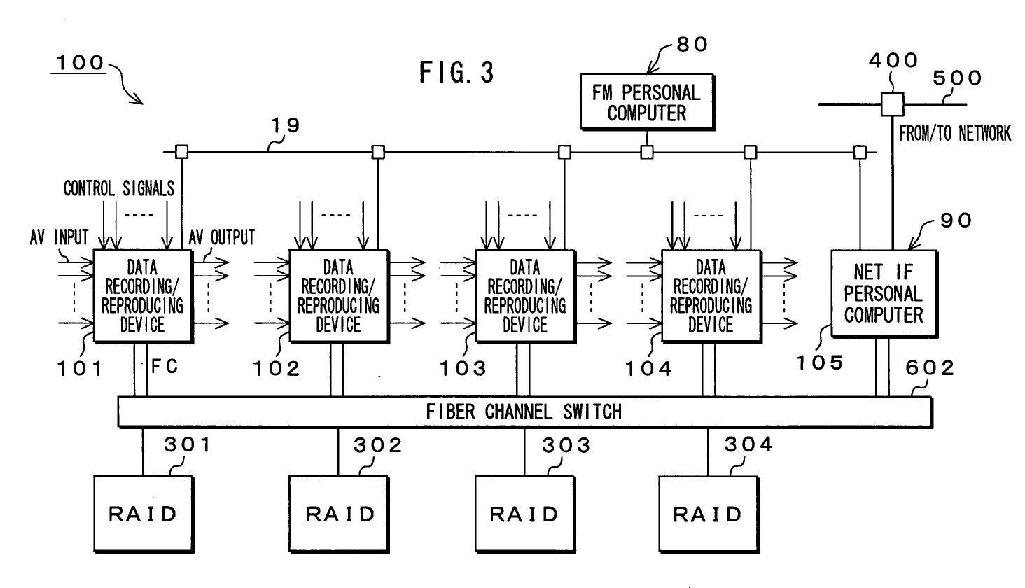

FIG. 3 shows an internal configuration of an embodiment of the AV server 100. The AV server 100 shown in FIG. 3 has apersonal computer (hereinafter referred to as “FM personal computer 80”) for file system (as a file manager), a personal computer (hereinafter referred to as “Net IF personal computer 90”) for network interface, four data recording/reproducing devices 101-104, four data storage devices (hereinaf ter referred to as “RAID”) 301-304, anda fiber channel switch 602.

The FM personal computer 80 is connected to the Net IF personal computer 90 and the four data recording/reproducing devices 101-104 through a local area network (LAN) 19 such as ETHERNET (trade mark). The FM personal computer 80 administrates any additional information (file information) of the AV data stream to be managed in the AV server 100. The FMpersonal computer 80 holds any information to be positioned in any file header portion and file footer portion, which are added to the AV data stream, via the data recording/reproducing device 101 or the like.

The Net IF personal computer 90 is connected with the network 500. The Net IF personal computer 90 receives any data stream with multipurpose format from a data-supplying system and separates any additional information from the received data stream to hold and manage it. The data stream with multipurpose format is constituted of AV data stream, which includes audio data and video data, and any additional information. The additional information includes a file header portion and a file footer portion. For example, the Net IF personal computer 90 performs any addition or any deletion of the file header portion and the file footer portion based on information from the FFM personal computer 80 when the Net IF personal computer 90 receives or transmits the data via the network. The addition or deletion is performs so that the AV server 100 can record or administrate the data stream with multipurpose format from the network 500 exactly and smoothly.

Each of the data recording/reproducing devices 101-104 is connected with the fiber channel switch 602 through an optical communication line (fiber channel (FC)) to implement any high-speed write/read operations of data. The fiber channel switch 602 is connected with the four RAIDs 301-304. As the RAIDs 301-304, recording medium or the like such as a magnetic disk or a magneto optical disk is used.

When recording the data, the data recording/reproducing device 101 receives any information on video and audio materials (SDI data as AV input) and encodes and compresses (performs encoding on) the SDI data according to a predetermined compression standard (MPEG or the like) under the recording control of the control terminal 200. The SDI data relates to any information on video and audio materials that is produced or edited according to NTSC scheme or PAL scheme in a broadcast station or an information distribution center on video and audio. The data recording/reproducing device 101 adds any additional information to the AV data stream that is obtained by compressing the SDI data to produce anAV data streamwithapredetermined format. The AV data stream is recorded in any of the RAIDs 301-304 through the fiber channel switch 602.

When reproducing the data, the data recording/reproducing device 101 reads the AV data stream with a predetermined data format based on the additional information from any of the RAIDs 301-304 under the reproducing control of the control terminal 200. For example, the data recording/reproducing device 101 decodes and uncompresses (performs decoding on) the AV data stream with a predetermined data format, which is read out of the RAID 301. The data recording/reproducing device 101 then outputs the SDI data thus decoded and uncompressed as the AV output to, for example, an image display device or an audio output device.

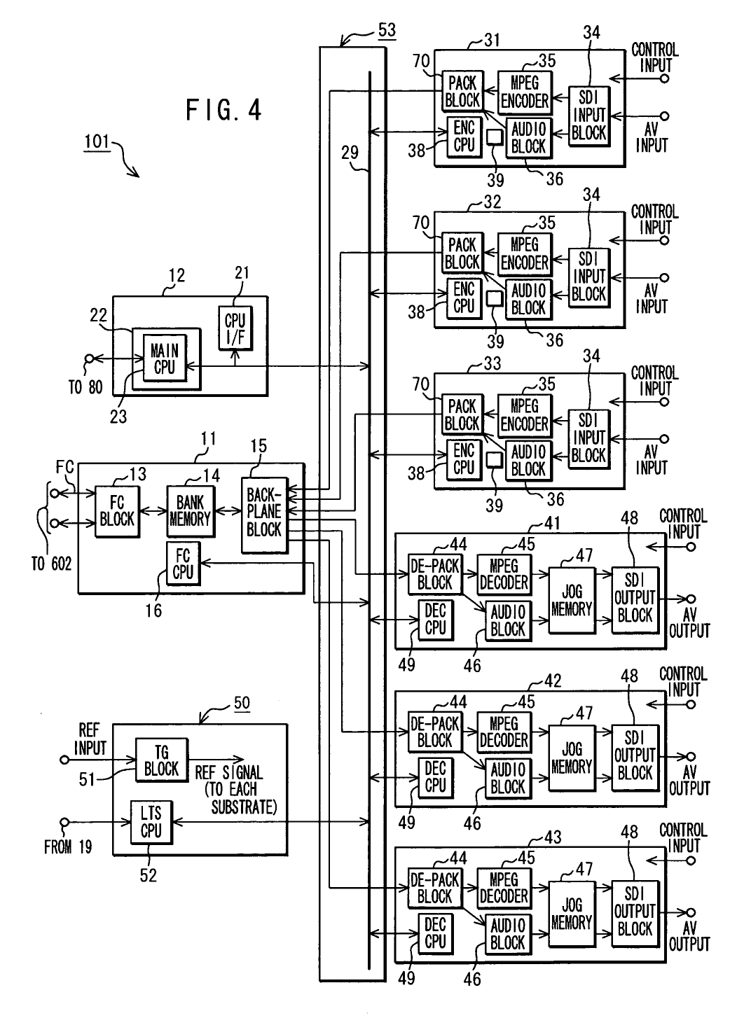

FIG. 4 shows an internal configuration of an embodiment of the data recording/reproducing device 101 according to the invention.

The data recording/reproducing device 101 shown in FIG. 4 has one substrate for inputting/outputting data to/from the fiber channel (hereinafter referred to as “FC input/output substrate 11”), three encoder substrates (hereinafter referred to as “ENC substrates 31-33”), three decoder substrates (hereinafter referred to as “DEC substrates 41-43”), and one record/reproduction control substrate 12. It is to be noted that the three DEC substrates 41-43 are separately operated and each DEC substrate has two decoder chips wherein each decoder chip receives data at the same time while each decoder chip decodes and reproduces data with a time difference when the reverse direction reproduction is carried out at a same speed as the recording speed.

The record/reproduction control substrate 12 has a CPU interface (hereinafter referred to as “CPU I/F circuit 21”) and a CPU block 22. The CPU block 22 has a main CPU 23. The main CPU 23 controls circuits and/or memories mounted on the FC input/output substrate 11. For example, the CPU 23 acquires any information on a writing area in the RAID 301 from the FM personal computer 80 and allows the RAID 301 to record the AV data stream when data of the AV data stream occupies a previously reserved address area in a bank memory 14 mounted on the FC input/output substrate 11. An I/O port, which is not shown, of the record/reproduction control substrate 12 is connected with an AV serial backplane 53. To the AV serial backplane 53, the FC input/output substrate 11 is connected.

The FC input/output substrate 11 is configured as a recording/reproducing portion. The FC input/output substrate 11 has a fiber channel interface circuit (hereinafter referred to as “FC block 13”), a bank memory 14, an encoder/decoder interface circuit (hereinafter referred to as “backplane block 15”), and an FC sub CPU 16. The FC block 13 is constituted of field programmable gate array (FPGA) and has an optical signal processing function. For example, the FC block 13 is connected with the fiber channel switch 602 to which an optical signal modulated on the basis of the AV data stream is transmitted.

The FC block 13 also has an optical-signal-processing portion, which is not shown, for performing any optical signal processing based on the data stream. The FC block 13 is connected to the bank memory 14 that stores the AV data stream in units of frame. For example, the AV data stream is written to an indicated address area in the bank memory 14. Information on the address area is added (placed) on the AV data stream one upon another.

The AV data stream is transferred to the address area indicated by the information. This allows the bank memory 14 to perform buffering of the AV data stream. As the bank memory 14, a hard disk or the like is used. The bank memory 14 is connected with the backplane block 15. The backplane block 15 is connected with the AV serial backplane 53 that receives and transmits the AV data stream from and to an I/O port of each of the ENC substrates 31-33 and the DEC substrates 41-44.

The FC sub CPU 16, which is constituted of FPGA and is local and auxiliary CPU (Nios) against the main CPU 23 (shown as FC CPU in the drawing), is built in the FC input/output substrate 11. The FC sub CPU 16 arbitrates destinations to which the AV data streams that are received from the plural ENC substrates 31-33 are transferred when recording the data. The FC sub CPU 16 also controls the bank memory 14 to read and write the AV data stream based on any control commands from the main CPU 23 and performs access control to RAID 301 or the like via the fiber channel switch 602. For example, the FC sub CPU 16 receives from the main CPU 23 the information on an area where the AV data stream is to be written in RAID 301 and controls the FC block 13 to write the AV data stream stored on the bank memory 14 to RAID 301 based on this information.

To the AV serial backplane 53, the ENC substrates 31-33 and the DEC substrates 41-44 are connected. The ENC substrate 31 has an SDI input block 34, an MPEG encoder 35, an audio block 36, an ENC sub CPU 38 (shown as ENC CPU in the drawing), a mini bank memory 39, and a pack block 70.

The ENC substrate 31 receives audio/video signal SDI of NTSC scheme or PAL scheme when recording the data and encodes and compresses (performs encoding on) the received signal SDI based on any signal compression standard such as MPEG. The ENC substrate 31 adds any additional information to audio/video data that is obtained by compressing the signal SDI to produce an AV data stream. The ENC substrate 31 transmits the AV data stream to the FC input/output substrate 11 at any time under the control of the main CPU 23 for every time when the AV data stream of one frame is stored in the bank memory 14. This is carried out when the ENC substrate 31 receives any control signals from the control terminal 200. The ENC substrate 31 and the like are connected to the control terminal 200 through a communication cable using any communication protocol such as RS-422A.

In this embodiment, relative to instruction which position in the bank memory 14 the AV data stream is to be transferred to, information thereon is placed on the AV data stream one upon another. This enables the AV data stream to be written in an instructed address area in the bank memory 14. Similarly, other ENC substrates 32 and 33 receive audio/video signal SDI and transfer the AV data stream. These other ENC substrates 32 and 33 have the same configuration and function as those of the ENC substrate 31, a detailed explanation of which will be omitted.

The DEC substrate 41 has a de-pack block 44, an MPEG decoder 45, an audio block 46, a jog memory 47, an SDI output block 48, and an DEC sub CPU 49 (shown as DEC CPU in the drawing).

When reproducing the data, the DEC substrate 41 receives the AV data stream from the bank memory 14 by the de-pack block 44. The de-pack block 44 separates any additional information from the AV data stream to produce MPEG data stream. The de-pack block 44 transmits the MPEG data stream from which the additional information is separated to the MPEG decoder 45 and the audio block 46, respectively. The MPEG decoder 45 decodes and decompresses (performs decoding on) the MPEG data stream based on a predetermined MPEG standard to output the video data. The audio block 46 performs decoding on the MPEG data stream to output the audio data.

The jog memory 47 stores audio and video data thus de-packed and decoded. In the jog memory 47, the data is bound to and separated from any decoding system in units of frame using its link function. The jog memory 47 can link separate frames to each other, not continuous frames, to reproduce continuous images.

In this embodiment, in the jog memory 47, a threshold value for determining an amount of data is set to compare the threshold value with an amount of audio and video data thus de-packed and decoded. If the amount of audio and video data falls down below the threshold value, the DEC sub CPU 49 controls DEC substrates 41 and 42 to perform de-packing and decoding on data of a next GOP.

The audio and video data thus decoded becomes SDI data. The jog memory 47 transmits such the SDI data to, for example, an image display device or an audio output device through the SDI output block 48. In this embodiment, using the jog memory 47 and two DEC substrates 41 and 42 allow images to be smoothly reproduced in a minus direction with a good continuity in the images.

It is to be noted that the DEC substrate 41 receives any control signals from the control terminal 200. The DEC substrate 41 and the like are connected to the control terminal 200 through a communication cable using any communication protocol such as RS-422A. Similarly, other DEC substrates 42 and 43 receive the AV data stream and transmit SDI data. These other DEC substrates 42 and 43 have the same configuration and function as those of the DEC substrate 41, a detailed explanation of which will be omitted.

In the above AV serial backplane 53, a CPU bus 29 is provided. To the CPU bus 29, the FC sub CPU 16, the main CPU 23, the ENC sub CPU 38 on each of the ENC substrates 31-33, the DEC sub CPU 49 on each of the DEC substrates 41-43, and an REF input substrate 50 are connected. The REF input substrate 50 has a timing generator (TG) block 51 and LTS sub CPU 52 (shown as LTS CPU in the drawing). The TG block 51 receives an REF signal (frame synchronizing signal) and supplies the REF signal to each of the substrates 11, 12, 31-33, 41-43, and the like under the control of the LTS sub CPU 52. The LTS sub CPU 52 is connected to the FM personal computer 80 and the Net IF personal computer 90 via ETHERNET (trade mark) 19 and to the CPU bus 29 to communicate with the FM personal computer 80, the Net IF personal computer 90, the main CPU 23 and the like. In this embodiment, other data recording/reproducing devices 102-104 have the same configuration as that of the data recording/reproducing device 101, a detailed explanation of which will be omitted.

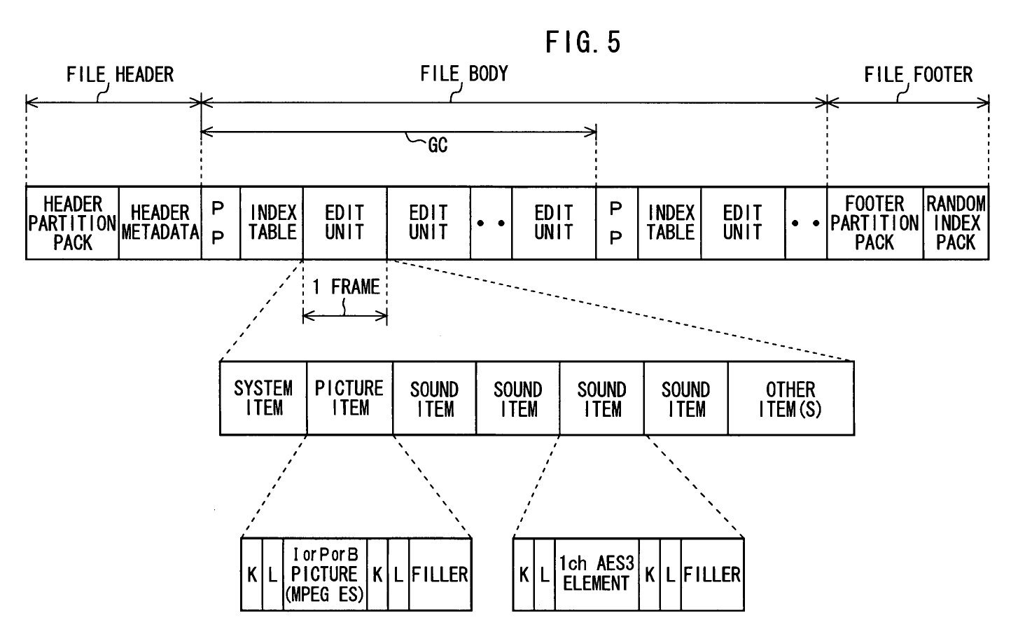

FIG. 5 shows a format example of a data structure in MXF file.

The data structure in MXF fileshown in FIG.5 is preferably applied to an AV multiple data format, which is used in an embodiment of the AV server system 1 according to the invention. In the data structure in MXF file, the AV data stream is constituted of a file header portion, a file body portion, and a file footer portion, which have a hierarchy structure.

The file body portion includes video data and audio data that are multiplex as the AV data stream, for example, in units of 60 frames (in a case of NTSC). This MXF file corresponds to any various recording formats without depending on a platform and corresponds to Quick Time (QT) (trade mark) that is scalable software.

The file header portion includes any necessary information for reproducing and/or editing the video data and audio data arranged in the file body portion according to the MXF standard using QT. In the file header portion, Run In, Header Partition Pack, and Header Metadata are arranged in turn as MXF header from a top thereof to an end thereof.

The Run In is an option for interpreting a start of the MXF header if a pattern by 11 bytes is met. The Run In can be saved up to 64 kilo bytes at a maximum but to 8 bytes in this embodiment. As Run In, any other than the pattern by 11 bytes can be used in the MXF header.

The Header Partition Pack includes the pattern by 11 bytes that is used for identifying the file header portion, information indicating a form of data that is arranged in the file body portion and a file format thereof and the like. The Header Metadata includes information that is necessary for reading the AV data arranged in the file body portion.

The file body portion is constituted of a generic container (GC) or an essence container (EC). The generic container includes a Partition Pack (PP), an Index Table, Edit Units. The Edit Units are arranged in unites of frame from a first frame to tenth frame.

The file footer portion includes a footer partition pack and a random index pack.

The Edit Unit of one frame includes the AV data that is multiplex, for example, in units of 60 frames (in a case of NTSC). The Edit Unit of one frame includes a System Item, a Picture Item, a Sound Item, and Other Item(s) (Auxiliary).

The System Item describes a local time code (LTC), UMID, and EssenceMark. The Sound Item includes, forexample, fourblocks. The Picture Item includes a key (K) and a data length (L) as well as I, P or B picture (MPEG ES) as a lower hierarch thereof, followed by K, L, and Filler. The Sound Item includes K and L as well as 1ch AES3 Element as a lower hierarch thereof, followed by K, L, and Filler.

The file footer portion includes Footer Partition Pack. The Footer Partition Pack includes data for identifying the file footer portion.

If giving the MXF file thus configured, the AV server 100 based on the MXF standard first reads the pattern by 11 bytes in the Header Partition Pack to discover the MXF header. The AV server 100 can read the AV data included in the GC based on the Header Metadata in the MXF header.

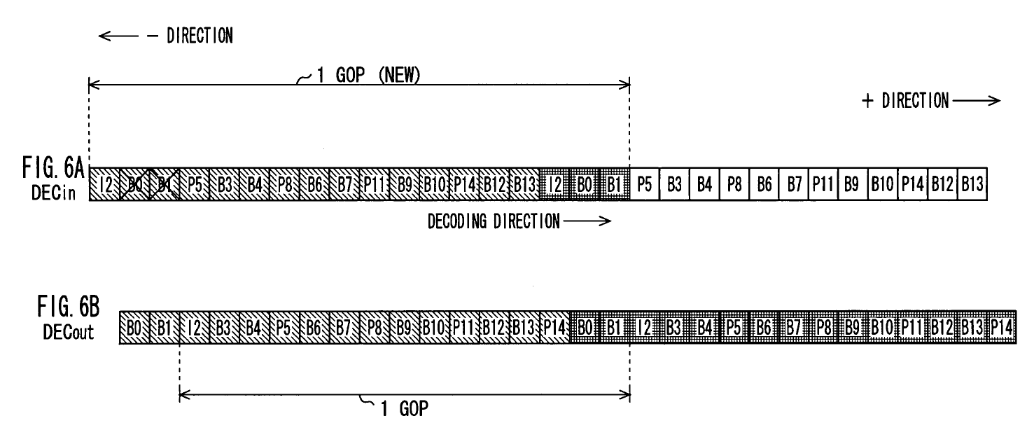

FIGS. 6A and 6B show an example for grouping the pictures in MPEG data stream when a reverse direction reproduction is carried out.

In related art, in order to produce an image based on a current GOP, it is necessary to decode a previous GOP and then, to perform any decoding. In this embodiment, pictures, B0 and B1 of the current GOP are removed (omitted) from a subject of decoding and instead of them, pictures, B0 and B1 of a next GOP are used therefor. The pictures of the current GOP from which the pictures, B0 and B1 are removed and the pictures, B0 and B1 of next GOP are then decoded in turn, thereby producing reverse production images made of fifteen pictures, from the picture, I2 to thepicture, B1, which have continuity. A jog memory can store data of the reverse production images.

An MPEG data stream DECin shown in FIG. 6A is an MPEG data stream that, for example, the DEC substrate 41 receives from the bank memory (data storage portion) 14 when reproducing the data. The RAID 301 has read the MPEG data stream DECin as an MPEG data stream constituted of one-grouped pictures of I2, B0, B1, P5, B3, B4, P8, B6, B7, P11, B9, B10, P14, B12, and B13 in turn on B picture, P picture and I picture to transmit it to the bank memory 14.

The main CPU 23 constituting the control device in this embodiment rearranges the pictures in the MPEG data stream DECin when reproducing the data so that the MPEG data stream can be constituted of one-grouped pictures of I2, P5, B3, B4, P8, B6, B7, P11, B9, B10, P14, B12, B13, I2, B0, and B1 in turn on the B picture, the P picture and the I picture. In this time, the main CP 23 removes the pictures, B0 and B1 of the current GOP and instead of them, the main CPU 23 adds pictures, I2, B0 and B1 of next GOP to the pictures of the current GOP from which the pictures, B0 and B1 are removed.

In other words, in order to group the pictures newly, the main CPU 23 controls the DEC sub CPU 49 to remove the pictures, B0 and B1 of the B picture of the current GOP, to rearrange the pictures so that the MPEG data stream can be constituted of one-grouped pictures of I2, P5, B3, B4, P8, B6, B7, P11, B9, B10, P14, B12, and B13 in turn on the remaining B picture, the P picture and the I picture, to transmit them from the bank memory 14 to the DEC substrate 41, and to transmit the pictures, I2, B0 and B1 of the next GOP.

Relative to the grouped pictures of the MPEG data stream thus read under the control of the DEC sub CPU 49, the DEC substrate 41 decodes the MPEG data stream to produce B pictures from previous and next P and I pictures or previous and next P pictures and to produce P pictures from previous I picture or previous P picture. The DEC substrate 41 then stores in the jog memory 47, as a decoder output DECout shown in FIG. 6B, the reproduced image data that is constituted of one-grouped pictures of I2, B3, B4, P5, B6, B7, P8, B9, B10, P11, B12, B13, P14, B0, and B1 in turn on the B picture, the P picture and the I picture. Thus, using the pictures, B0 and B1 of the next GOP as the pictures of the current GOP allow to be reproduced a reproduction image that is constituted of only an amount of almost one GOP data.

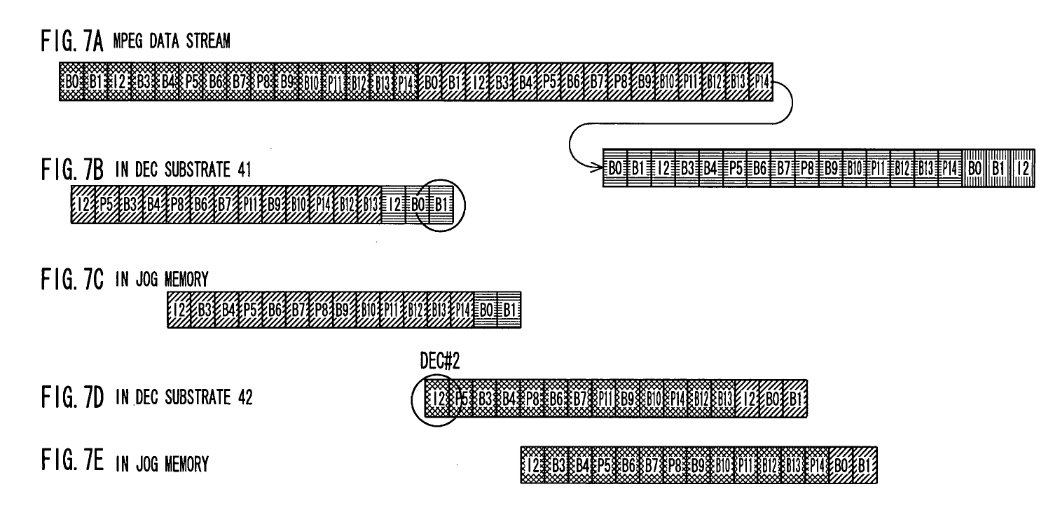

FIGS. 7A through 7E show a timing example of a start of decoding in each of the DEC substrates 41, 42.

In the MPEG data stream shown in FIG. 7A, relative to a minus direction reproduction mode, the MPEG data stream is decoded in a direction of a right arrow shown in FIG. 7A and reproduced in a reverse direction of a left arrow shown in FIG. 7A. On the assumption of this, in the data recording/reproducing device 101, the MPEG data stream constituted of one-grouped pictures of I2, P5, B3, B4, P8, B6, B7, P11, B9, B10, P14, B12, B13, I2, B0, and B1 in turn on the B picture, the P picture and the I picture, as shown in FIG. 7B, is transferred from the bank memory 14 to the DEC substrate 41. The DEC substrate 41 then decodes the MPEG data stream to produce B pictures from previous and next P and I pictures or previous and next P pictures and to produce P pictures from previous I picture or previous P picture. Thus, the jog memory 47 stores de-packed and decoded image data that is constituted of one-grouped pictures of I2, B3, B4, P5, B6, B7, P8, B9, B10, P11, B12, B13, P14, B0, and B1 in turn on the B picture, the P picture and the I picture, as shown in FIG. 7C.

In this embodiment, when the DEC substrate 41 decodes the final picture, B1, the DEC substrate 42 receives the MPEG data stream that is included in a next reversely reproduced group and is constituted of one-grouped pictures of I2, P5, B3, B4, P8, B6, B7, P11, B9, B10, P14, B12, B13, I2, B0, and B1 in turn on the B picture, the P picture and the I picture, as shown in FIG. 7D, from the bank memory 14 and starts decoding them. In other words, the DEC substrate 42 starts decoding the picture, I2 of the GOP to be next reversely reproduced simultaneously with the DEC substrate 41 decoding the picture, B1 of the current GOP after decoding the picture, B0 of the current GOP. This is because if an image is reversely reproduced at a same speed as the recording, one decoder may make the reproduction of images incomplete when the decoder decodes pictures in order. Thus, when an amount of decoded data in the first DEC substrate 41 exceeds over a threshold value in the jog memory 47, the second DEC substrate 42 is used to decode the pictures of the next GOP. Two decoders are necessary for decoding the overlapped portions encircled with circles shown in FIGS. 7B and 7D.

The DEC substrate 42 decodes the MPEG data stream to produce B pictures from previous and next P and I pictures or previous and next P pictures and to produce P pictures from previous I picture or previous P picture, similar to those of the DEC substrate 41. Thus, the jog memory 47 further stores de-packed and decoded image data that is constituted of one-grouped pictures of I2, B3, B4, P5, B6, B7, P8, B9, B10, P11, B12, B13, P14, B0, and B1 in turn on the B picture, the P picture and the I picture, as shown in FIG. 7E.

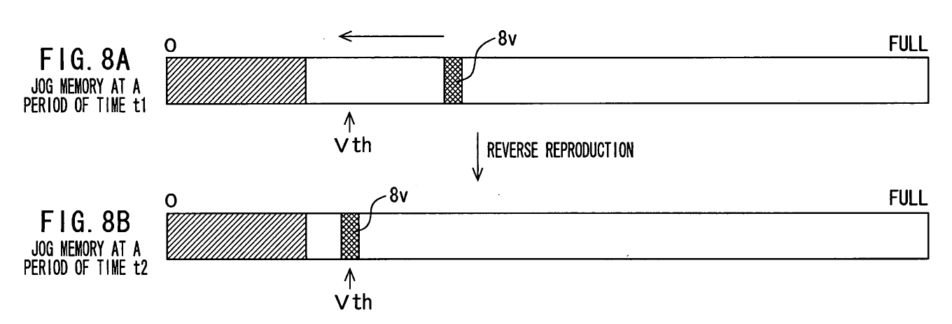

FIGS. 8A and 8B show a transition example in an amount of stored data within the jog memory 47. As shown in FIGS. 8A and 8B, a threshold value Vth is set in the jog memory 47. A shade indicator 8v shown in each of the FIGS. 8A, 8B is a cursor for indicating a decrease state of the AV data. In this embodiment, the shade indicator 8v moves from right side toward left side in FIG. 8A, like an arrow direction shown therein when the data is reproduced in a minus direction. FIG. 8A shows data storage state within the jog memory 47 at a period of time t1. At a state shown in FIG. 8A, the shade indicator 8v stays in a position away from the threshold value Vth in the right side so that the second decoder may stop its operation.

Time is elapsed to become a period of time t2. When the shade indicator 8v moves to the threshold value Vth or below, the DEC substrate 42 receives from the bank memory 14 the MPEG data stream constituted of one-grouped pictures of I2, P5, B3, B4, P8, B6, B7, P11, B9, B10, P14, B12, B13, I2, B0, and B1 in turn on the next GOP and starts decoding it. This is because continuity, responsibility, and smoothness of images and sounds are improved.

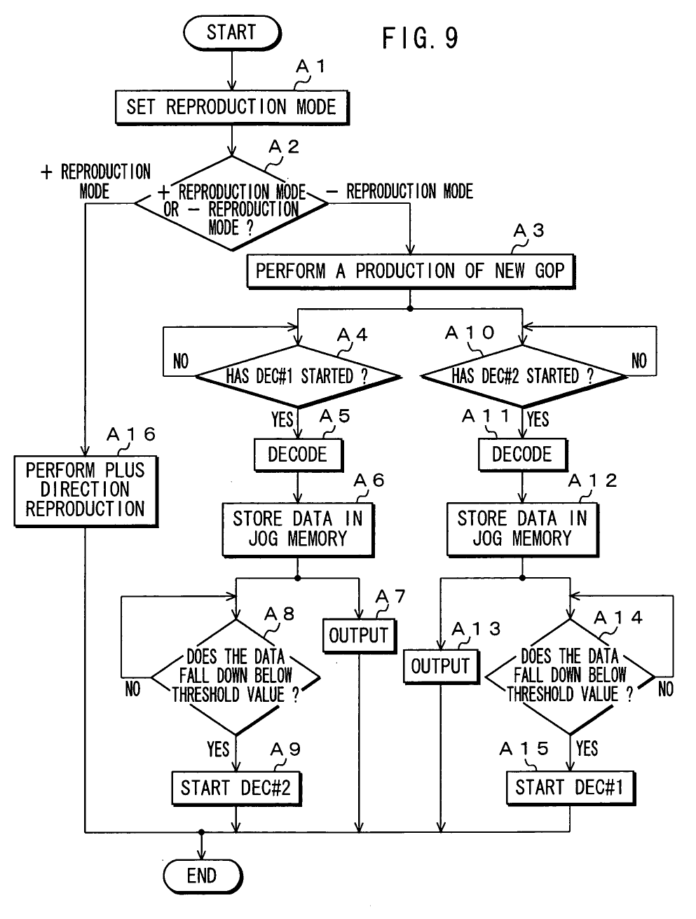

The following will describe an embodiment of information recording/reproducing method according to the invention. FIG. 9 is a flowchart for showing operations of the embodiment of the data recording/reproducing device 101 according to the,invention when the reverse direction reproduction is carried out.

In this embodiment, a minus direction reproduction mode (hereinafter referred to as “reverse direction reproduction mode”) and a plus direction reproduction mode (hereinafter referred to as “forward direction reproduction mode”) are selectable in the reproduction mode. In an MPEG data stream constituted of one-grouped pictures of I2, B0, B1, P5, B3, B4, P8, B6, B7, P11, B9, B10, P14, B12, and B13 in turn on B picture, P picture and I picture, instead of the pictures, B0 and B1, of this group, pictures B0 and B1 of the next GOP are added to the MPEG data stream of the GOP of this group from which the pictures, B0 and B1 are removed so that the MPEG data stream of the GOP of the current GOP is produced. The second decoder starts decoding picture of I2 in a GOP to be next reversely reproduced at the same time as the first decoder decodes the picture of B1 in the current GOP after the first decoder has decoded the picture of B0 in the current GOP.

According to these operation conditions, at step A1 in the flowchart shown in FIG. 9, the process sets the reproduction mode. The control terminal 200 can send a control signal for setting the reproduction mode to the data recording/reproducing device 101 to set the reproduction mode.

Next, at step A2, the main CPU 23 branches its control based on the reproduction modes. If the reverse direction reproduction mode is selected, the process goes to step A3 where the main CPU 23 performs a production of new GOP. The main CPU 23 produces the MPEG data stream constituted of one-grouped pictures of I2, P5, B3, B4, P8, B6, B7, P11, B9, B10, P14, B12, B13, I2, B0, and B1 in turn on the B picture, the P picture and the I picture, as shown in FIG. 6A. Such the newly produced MPEG data stream is obtained by removing the pictures, BO and B1 from the B picture of the current GOP, transmitting the MPEG data stream constituted of one-grouped pictures of I2, P5, B3, B4, P8, B6, B7, P11, B9, B1O, P14, B12, and B13 in turn on the remaining B picture, the P picture and the I picture from the bank memory 14 to the DEC substrate 41, and adding the pictures, I2, B0 and B1 of the next GOP thereto.

The process the goes to step A4 or A10. The steps A4 through A9 relate operations of a first decoder (hereinafter referred to as “DEC#1”) in the DEC substrate 41. The steps A10 through A15 relate operations of a second decoder (hereinafter referred to as “DEC#2”) in the DEC substrate 41. The process goes to the steps A4 through A9 or A10 through A15 basically one after the other. In a period of time, these steps can be operated at the same time.

At the step A4, the DEC substrate 41 waits for receiving a start command of DEC#1. If receiving the start command of DEC#1, the process goes to the step A5 where the decoding is carried out. The main CPU 23 controls the DEC sub CPU 49 to read the MPEG data stream from the bank memory 14 according to the above order of the pictures and to transmit it to the DEC substrate 41. The main CPU 23 adds the pictures, I2, B0 and B1 of the next GOP in stead of the pictures, B0 and B1 of the current GOP to the MPEG data stream of the current GOP from which the pictures, B0 and B1 are removed.

The DEC substrate 41 decodes the MPEG data stream constituted of one-grouped pictures to produce B pictures from previous and next P picture and I picture or previous and next P pictures and to produce P pictures from previous I picture and previous P picture and produces reversely reproduced image data that is constituted of one-grouped pictures of I2, B3, B4, P5, B6, B7, P8, B9, B10, P11, B12, B13, P14, B0, and B1 in turn on the B picture, the P picture and the I picture (see DECout shown in FIG. 6B). At step A6, the jog memory 47 stores the decoded data. At step A7, the jog memory 47 outputs SDI data to an image display device and/or an audio output device.

On the other hand, at the same time of the step A7, the jog memory 47 watches an amount of stored data at step A8. If the amount of stored data falls down below the threshold value, the process goes to step A9 where a trigger (a start command for DEC#2) for starting a second decoder in the DEC substrate 41 is transferred to the second decoder in the DEC substrate 41. It is to be noted that at a period of time when decoding one GOP is completed, the first decoder in the DEC substrate 41 stops decoding and waits for a next start command for DEC#1.

In this embodiment, since the DEC substrate 41 waits for receiving a start command of DEC#2 at the step 10, the process goes to the step All where the decoding starts if receiving the start command of DEC#2 in the step A9. At step A12, the jog memory 47 stores the decoded data, forexample, DECout shown in FIG. 6B. At step A13, the jogmemory 47 outputs SDI data to an image display device and/or an audio output device.

On the other hand, at the same time of the step A13, the jog memory 47 watches an amount of stored data at step A14. If the amount of stored data falls down below the threshold value, the process goes to step A15 where a trigger (a start command for DEC#1) for starting a first decoder in the DEC substrate 41 is transferred to the first decoder in the DEC substrate 41. It is to be noted that at a period of time when decoding one GOP is completed, the second decoder in the DEC substrate 41 stops decoding and waits for a next start command for DEC#2. Thus, the first and second decoders in the DEC substrate 41 operate one after the other (toggle scheme) to carry out the reverse direction reproduction mode including a period of time when the steps are partially operated at the same time.

If the forward direction reproduction mode is selected at step A2, the process goes to step A16 where the first and second decoders in the DEC substrate 41 carry out the plus direction reproduction processing according to the method similar to related art.

Thus, to an embodiment of the AV server system 1 of the invention, the data recording/reproducing device 101 and the information recording/reproducing method are applied. The main CPU 23 allows the bank memory 14 to read therefrom the MPEG data stream constituted of one-grouped pictures of I2, P5, B3, B4, P8, B6, B7, P11, B9, B10, P14, B12, B13, I2, B0, and B1 in turn on the B picture, the P picture and the I picture.

The Dec substrate 41 decodes the MPEG data stream constituted of one-grouped pictures that is read out by the DEC sub CPU 49, to produce B pictures from previous and next P picture and I picture or previous and next P pictures and to produce P pictures from previous I picture or previous P picture, stores in the jog memory the reproduced image data that is constituted of one-grouped pictures of I2, B3, B4, P5, B6, B7, P8, B9, B10, P11, B12, B13, P14, B0, and B1 in turn on the B picture, the P picture and the I picture, and controls data-reading order out of the jog memory.

Thus, in these embodiments, it is possible to produce any reverse reproduction images, rapidly, which have continuity, from the MPEG data stream of almost one GOP. This allows the reverse direction reproduction at a same speed as the recording speed to be implemented in MPEG long GOP. Further, in a variable speed reproduction, even when a reproduction direction is switched from its plus direction to its minus direction and vice versa, it is possible to get any reverse reproduction images in which smoothly reversed movement in an image can be given without lacking (skipping) any necessary picture if using the images stored in the jog memory.

By controlling reading items of reproduction image data decoded by the first and second decoders in the DEC substrate 41 out of the jog memory 47 allow the reverse direction reproduction at a same speed as the recording speed and an improvement in response to be implemented in MPEG long GOP.

The embodiments of the invention are preferably applied to an AV server system having reverse direction reproduction mode that reproduces an audio/video data stream in a minus direction.

It should be understood by those skilled in the art that various modifications, combinations, sub-combinations and alternations may occur depending on design requirements and other factors insofar as they are within the scope of the appended claims or the equivalents thereof.

What is claimed is:

1. Information recording/reproducing system comprising:
data storage device that stores an MPEG data stream constituted of one-grouped pictures of I2, B0, B1, P5, B3, B4, P8, B6, B7, P11, B9, B10, P14, B12, and B13 in turn on B picture, P picture and I picture;
control device that controls the data storage device to read the MPEG data stream constituted of one-grouped pictures of I2, P5, B3, B4, P8, B6, B7, P11, B9, B10, P14, B12, B13, I2, B0, and B1 in turn on the B picture, the P picture and the I picture; and
information recording/reproducing apparatus including a memory, said apparatus decoding the MPEG data stream constituted of one-grouped pictures read out of the data storage device by the control device to produce B pictures from any one of previous and next P picture and I picture and previous and next P pictures and to produce P pictures from any one of previous I picture and previous P picture, storing in the memory reproduced image data that is constituted of one-grouped pictures of I2, B3, B4, P5, B6, B7, P8, B9, B10, P11, B12, B13, P14, B0, and B1 in turn on the B picture, the P picture and the I picture, and controlling data-reading order out of the memory.

2. The information recording/reproducing system of claim 1, wherein, instead of the pictures of B0 and B1 in the MPEG data stream constituted of one-grouped pictures of I2, B0, B1, P5, B3, B4, P8, B6, B7, P11, B9, B10, P14, B12, and B13 in turn on the B picture, the P picture and the I picture, the control device supplements this grouped pictures with pictures of B0 and B1 in a next group.

3. The information recording/reproducing system of claim 1, wherein the information recording/reproducing apparatus comprises a first decoder and a second decoder each decoding the MPEG data stream to produce B pictures from any one of previous and next P picture and I picture and previous and next P pictures and to produce P pictures from any one of previous I picture and previous P picture, and
wherein the second decoder starts decoding picture of I2 in a group to be next reversely reproduced at the same time as the first decoder decodes the picture of B1 in a current group after the first decoder has decoded the picture of B0 in the current group.

4. Information recording/reproducing apparatus comprising:
data storage portion that stores an MPEG data stream constituted of one-grouped pictures of I2, B0, B1, P5, B3, B4, P8, B6, B7, P11, B9, B10, P14, B12, and B13 in turn on B picture, P picture and I picture;
control portion that controls the data storage portion to read the MPEG data stream constituted of one-grouped pictures of I2, P5, B3, B4, P8, B6, B7, P11, B9, B10, P14, B12, B13, I2, B0, and B1 in turn on the B picture, the P picture and the I picture; and
information recording/reproducing portion including a memory, said information recording/reproducing portion decoding the MPEG data stream constituted of one-grouped pictures read out of the data storage portion by the control portion to produce B pictures from any one of previous and next P picture and I picture and previous and next P pictures and to produce P pictures from any one of previous I picture and previous P picture, storing in the memory reproduced image data that is constituted of one-grouped pictures of I2, B3, B4, P5, B6, B7, P8, B9, B10, P11, B12, B13, P14, B0, and B1 in turn on the B picture, the P picture and the I picture, and controlling data-reading order out of the memory.

5. The information recording/reproducing apparatus of claim 4, wherein, instead of the pictures of B0 and B1 in the MPEG data stream constituted of one-grouped pictures of I2, B0, B1, P5, B3, B4, P8, B6, B7, P11, B9, B10, P14, B12, and B13 in turn on the B picture, the P picture and the I picture, the control portion supplements this grouped pictures with pictures of B0 and B1 in a next group.

6. The information recording/reproducing apparatus of claim 4, wherein the information recording/reproducing portion comprises a first decoder and a second decoder each decoding the MPEG data stream to produce B pictures from any one of previous and next P picture and I picture and previous and next P pictures and to produce P pictures from any one of previous I picture and previous P picture, and
wherein the second decoder starts decoding picture of I2 in a group to be next reversely reproduced at the same time as the first decoder decodes the picture of B1 in a current group after the first decoder has decoded the picture of B0 in the current group.

7. The information recording/reproducing apparatus of claim 6, wherein the memory stores items of data obtained by decoding of the first and second decoders successively,
wherein a threshold value is set in the memory, and
wherein decode-starting timing is determined in each of the first and second decoders based on the threshold value.

8. Information recording/reproducing method comprising the steps of:
grouping an MPEG data stream constituted of pictures of I2, P5, B3, B4, P8, B6, B7, P11, B9, B10, P14, B12, B13, I2, B0, and B1 in turn on the B picture, the P picture and the I picture as one group relative to the MPEG data stream constituted of one-grouped pictures of I2, B0, B1, P5, B3, B4, P8, B6, B7, P11, B9, B10, P14, B12, and B13 in turn on B picture, P picture and I picture and recorded in this order;
decoding the MPEG data stream constituted of one-grouped pictures to produce B pictures from any one of previous and next P picture and I picture and previous and next P pictures and to produce P pictures from any one of previous I picture and previous P picture;
storing in a memory reproduced image data that is constituted of one-grouped pictures of I2, B3, B4, P5, B6, B7, P8, B9, B10, P11, B12, B13, P14, B0, and B1 in turn on the B picture, the P picture and the I picture; and
controlling data-reading order out of the memory.

9. The information recording/reproducing method of claim 8, wherein, instead of the pictures of B0 and B1 in the MPEG data stream constituted of one-grouped pictures of I2, B0, B1, P5, B3, B4, P8, B6, B7, P11, B9, B10, P14, B12, and B13 in turn on the B picture, the P picture and the I picture, this grouped pictures are supplemented with pictures of B0 and B1 in a next group.

10. The information recording/reproducing method of claim 8, wherein decoding picture of I2 in a next group starts at the same time as the decoding of the picture of B1 in a current group after decoding the picture of B0 in the current group.

11. Information recording/reproducing system comprising:
data storage means for storing an MPEG data stream constituted of one-grouped pictures of I2, B0, B1, P5, B3, B4, P8, B6, B7, P11, B9, B10, P14, B12, and B13 in turn on B picture, P picture and I picture;
control means for controlling the data storage device to read the MPEG data stream constituted of one-grouped pictures of I2, P5, B3, B4, P8, B6, B7, P11, B9, B10, P14, B12, B13, I2, B0, and B1 in turn on the B picture, the P picture and the I picture; and
information recording/reproducing means including a memory, said information recording/reproducing means decoding the MPEG data stream constituted of one-grouped pictures read out of the data storage means by the control means to produce B pictures from any one of previous and next P picture and I picture and previous and next P pictures and to produce P pictures from any one of previous I picture and previous P picture, storing in the memory reproduced image data that is constituted of one-grouped pictures of I2, B3, B4, P5, B6, B7, P8, B9, B10, P11, B12, B13, P14, B0, and B1 in turn on the B picture, the P picture and the I picture, and controlling data-reading order out of the memory.

12. Information recording/reproducing apparatus comprising:
data storage means for storing an MPEG data stream constituted of one-grouped pictures of I2, B0, B1, P5, B3, B4, P8, B6, B7, P11, B9, B10, P14, B12, and B13 in turn on B picture, P picture and I picture;
control means for controlling the data storage means to read the MPEG data stream constituted of one-grouped pictures of I2, P5, B3, B4, P8, B6, B7, P11, B9, B10, P14, B12, B13, I2, B0, and B1 in turn on the B picture, the P picture and the I picture; and
information recording/reproducing means including a memory, said information recording/reproducing means decoding the MPEG data stream constituted of one-grouped pictures read out of the data storage means by the control means to produce B pictures from any one of previous and next P picture and I picture and previous and next P pictures and to produce P pictures from any one of previous I picture and previous P picture, storing in the memory reproduced image data that is constituted of one-grouped pictures of I2, B3, B4, P5, B6, B7, P8, B9, B10, P11, B12, B13, P14, B0, and B1 in turn on the B picture, the P picture and the I picture, and controlling data-reading order out of the memory.
